(19) United States
(12) Patent Application Publication
(10) Pub. No.: US 2010/0116909 A1
(43) Pub. Date: May 13, 2010

(54) NOZZLE AND DISPENSER INCORPORATING A NOZZLE

(76) Inventor: Hassan Abduljalil, Manchester (GB)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/309,848

(22) PCT Filed: Jul. 30, 2007
(86) PCT No.: PCT/GB2007/002894

§ 371 Date: Oct. 19, 2009

(30) Foreign Application Priority Data
Aug. 1, 2006 (GB) 0615257.3

(51) Int. Cl. B05B 1/34

(52) U.S. Cl. 239/468

(57) ABSTRACT

A nozzle (10) has a fluid inlet, an outlet orifice (20) through which fluid can be expelled from the nozzle in the form of a spray, and a fluid passage for fluidly connecting the fluid inlet with the outlet orifice. The fluid passage includes a swirl chamber (14) immediately upstream of the outlet orifice (20) having opposed front and rear end faces (18, 16). At least one inlet orifice (24, 26) directs fluid into the chamber and the outlet orifice (20) is formed in the front end face (18) of the chamber. The swirl chamber has a minimum length measured from the front end face to the rear end face in the range of 0.03 mm to 0.6 mm and a ratio of maximum width Wmax to minimum length (W_{maχ}/Lₘᵢₙ) in the range of 10:1 to 40:1.

The present invention relates to a nozzle arrangement. More particularly, but not exclusively, the present invention relates to a nozzle arrangement for use in generating a spray of a fluid, which is forced to flow through the nozzle arrangement under pressure. The present invention also relates to a dispenser incorporating such a nozzle arrangement.

Nozzles are often used to provide a means of generating sprays of various fluids. In particular, nozzles are commonly incorporated into an actuator fitted to the outlet valves of pressurised fluid-filled containers, referred to hereinafter as “aerosol canisters”, to provide a means by which the fluid stored in the container can be dispensed in the form of an atomized spray or mist. A large number of commercial products are presented to consumers in this form, including, for example, antiperspirant sprays, de-odorant sprays, perfumes, air fresheners, antiseptics, paints, insecticides, polish, hair care products, pharmaceuticals, water and lubricants. In addition, nozzle arrangements are often incorporated in dispensers where the release of fluid from a non-pressurised container is achieved by means of a manually operable pump or trigger to generate an atomized spray or mist of certain fluid products. This type of dispenser will be referred to hereinafter as a manual pump dispenser. Examples of products that are typically dispensed using manual pump dispensers include various lotions, insecticides, as well as various garden and household sprays.

Whilst nozzles for aerosol canisters are usually incorporated into an actuator which is located at the end of a stem that extends from the aerosol valve, it has also been proposed to incorporate many of the features of a nozzle directly in the aerosol valve itself and/or in the stem. Accordingly, it should be understood that references to nozzle arrangements herein are intended to cover nozzle arrangements that are incorporated into an aerosol outlet valve or stem as well as nozzle arrangements that form part of an actuator mounted to the stem or valve of an aerosol canister or which are part of a manual pump dispenser.

Nozzle arrangements are also used in a variety of industrial applications where it is necessary to generate a spray of fluid. For example, misting nozzles are used in horticultural and cooling applications. Nozzle arrangements are also often used is used as part of a fuel injection system for engines and the like. It will be appreciated that nozzle arrangements in accordance with the invention may be adapted for any suitable application.

A spray is generated when a fluid is caused to flow through a nozzle arrangement under pressure. To form a spray, the nozzle arrangement is configured to cause the fluid stream passing through the nozzle to break up or “atomize” into numerous droplets as it is ejected through one or more outlet orifices.

The optimum size of the droplets required in a particular spray depends primarily on the particular product concerned and the application for which it is intended. For example, a pharmaceutical spray that contains a drug intended to be inhaled by a patient (e.g. an asthmatic patient) usually requires very small droplets, which can penetrate deep into the lungs. In contrast, a polish spray preferably comprises spray droplets with larger diameters to promote the impaction of the aerosol droplets on the surface that is to be polished and, particularly if the spray is toxic, to reduce the extent of inhalation.

The size of the aerosol droplets produced by conventional nozzle arrangements is dictated by a number of factors, including the dimensions of the outlet orifice and the pressure with which the fluid is forced through the nozzle. However, problems can arise if it is desired to produce a spray that comprises small droplets with a narrow droplet size distribution, particularly at low pressures. The use of low pressures for generating sprays is becoming increasingly desirable because it enables low pressure nozzle devices, such as the manual pump dispensers, to be used instead of more expensive aerosol containers and, in the case of the aerosol containers, it enables the quantity of propellant present in the spray to be reduced, or alternative propellants which typically produce lower pressures (e.g. compressed gas) to be used. The desire to reduce the level of propellant used in aerosol canisters is a topical issue at the moment and is likely to become more important in the future due to legislation planned in certain countries, which proposes to impose restrictions on the amount of propellant that can be used in hand-held aerosol canisters for reasons discussed below. The reduction in the level of propellant causes a reduction in the pressure available to drive the fluid through the nozzle arrangement and also results in less propellant being present in the mixture to assist with the droplet break up. Therefore, there is a requirement for a nozzle arrangement that is capable of producing an aerosol spray composed of suitably small droplets at low operating pressures.

A further problem with known pressurised aerosol canisters fitted with conventional nozzle arrangements is that the size of the aerosol droplets generated tends to increase during the lifetime of the aerosol canister, particularly towards the end of the canister's life as the pressure within the canister reduces as the propellant becomes gradually depleted. This reduction in pressure causes an observable increase in the size of the aerosol droplets generated and thus, the quality of the spray produced is compromised.

The problem of providing a high quality spray at low pressures is further exacerbated if the fluid concerned has a high viscosity because it becomes harder to atomise the fluid into sufficiently small droplets.

Various proposals have been made to improve nozzle arrangements in order to overcome, or at least reduce, the problems outline above.

To assist in the beak up of liquids at the nozzle outlet, it is known to mix a gas into the liquid stream. The arrangement is such that as the liquid and gas mixture exits the nozzle outlet orifice, the gas expands helping to break the fluid into smaller droplets. In the case of aerosol canisters, certain propellants are present in the canister the form of a liquefied gas in suspension in the liquid product as well as a gas or vapour above the liquid product. When the liquid product is dispensed, the liquefied gas held in suspension will expand as it passes through the nozzle outlet orifice into the atmosphere, breaking the liquid product up into small droplets. Typical liquefied gas propellants include propane, butane, isobutene, n-butane, and dimethyl ether, all of which are volatile organic compounds (VOCs). VOCs are harmful to the environment and there is increasing legislative and ethical pressure to reduce the amount of VOCs used in aerosol canisters. Reduced VOC aerosols often have lower operating pressures and reduced amounts of propellant in suspension in the liquid. As result, it can be difficult to achieve effective sprays for certain products such as air fresheners and insecticides in particular.

Where a propellant is present in an aerosol canister as a vapour or compressed gas above the liquid, it is known to use a vapour phase tap to bleed some the propellant gas into the liquid as it is passes through the aerosol valve or the nozzle to be dispensed. The propellant gas is mixed with the liquid in the aerosol valve and/or the nozzle and helps the break up the liquid stream as it passes out through the outlet orifice. This arrangement may be required where there is no or only a small amount of propellant in suspension, as may be the case with a reduced VOC formulation or where an alternative non-VOC propellant such as carbon dioxide or nitrogen or compressed air is used. The problem with this arrangement is that the propellant gas is depleted more quickly resulting in the pressure in the canister dropping as the contents are used up, adversely affecting the quality of the spray.

In other applications, such as manual pump dispensers, it is known to mix a gas, usually air, with a liquid as it is being dispensed so that the gas expands as the mixture passes out of the nozzle into the atmosphere to break up the liquid into very small droplets. Such manual pump dispensers usually have at least one pump chamber for the liquid product to be dispensed and at least one further pump chamber for pressurising the gas. When the dispenser is actuated, the pressurised gas is mixed with the pressurised liquid to aid in the atomisation of the liquid at the nozzle.

It is also known to incorporate a swirl chamber into a nozzle arrangement in which the fluid is caused to spin before exiting the chamber through an outlet orifice. Known swirl chambers typically comprise a cylindrical chamber with an outlet orifice located centrally in a downstream or front end wall of the chamber. One or more fluid inlets are provided in the side of the chamber which direct the fluid tangentially on to the cylindrical wall so that the fluid spins in the chamber. Where there is more than one inlet orifice, all the inlet orifices feed the fluid into the chamber in the same circumferential direction. Swirl chambers are particularly useful in producing a conical spray pattern from the outlet orifice.

Whilst many known swirl chambers are cylindrical with a circular cross section, in some known arrangements the inlets which enter through the side walls are formed in a manner that squares off the circular cross section of chamber to an extent. Such chambers are nevertheless generally circular in cross section in order to encourage the fluid to spin in the chamber. It should be understood that references in the description and claims to a swirl chamber being generally circular in cross section do not require the chamber to be perfectly circular but are intended to cover any profile that approximates to a circle and in which the fluid is able to spin.

For convenience, when referring to a swirl chamber, the upstream end of the chamber through which the fluid exits the chamber will be referred to as the “front” end and the opposite, or downstream, end of the chamber will be referred to as the “rear” end.

A typical known swirl chamber is described in U.S. Pat. No. 6,367,711 B1 to Benoist. In this arrangement, four profiles are arranged in a circle to define a generally cylindrical chamber in the middle of the profiles. Spaces between adjacent profiles form inlets that direct the fluid tangentially into the central chamber so that the fluid is imparted with a swirling motion. A spray orifice is provided centrally in a front end wall of the chamber.

As disclosed in the applicant's International patent application published as WO 01/89958, it has also been found beneficial to incorporate a swirl chamber in a nozzle arrangement but spaced upstream from the final outlet orifice, as a means of controlling the droplet size and droplet size distribution in the final aerosol.

Many known swirl chambers generate a central core of air about which the fluid, typically a liquid such as a liqour, spins as it exits the outlet orifice. The air core is generated as a result of the liquid forming a vortex as it spins in the chamber which draws the core of air in from outside of the nozzle through the centre of the outlet orifice. Swirl chambers which form a core of air will give rise to a hollow cone shaped spray and can only be used adjacent the final outlet spray orifice of the nozzle.

Although conventional swirl chambers have been found to be effective, there is a need to provide a nozzle arrangement having an alternative swirl chamber configuration that can be used to further enhance the quality of spray produced and/or to produce a spray with characteristics that are different from those produced using a conventional swirl chamber.

In accordance with a first aspect of the invention, there is provided a nozzle having a fluid inlet, an outlet orifice through which fluid can be expelled from the nozzle in the form of a spray, and fluid flow passage for fluidly connecting the fluid inlet with the outlet orifice, the passage including a swirl chamber immediately upstream of the outlet orifice, the swirl chamber having opposing front and rear end faces, the fluid passage also including at least one inlet orifice through which fluid can be introduced into the swirl chamber with the outlet orifice of the nozzle being provide in the front end face of the swirl chamber, characterised in that the swirl chamber has a minimum length measured from the front end face to the rear end face in the range of 0.03 mm to 0.6 mm and a ratio of maximum width to minimum length (Wₘₐₓ/Lₘᵢₙ) in the range of 10:1 to 40:1.

The chamber may be generally circular in lateral dross section, in which case the maximum width of the chamber will be its largest diameter D.

The swirl chamber may have a minimum length in the range 0.1 mm to 0.3 mm.

The length of the swirl chamber may vary across its diameter so that its length is less in a central region surrounding the outlet orifice than in a radially outer region surrounding the central region. The front end face of the swirl chamber may be shaped to vary the length of the swirl chamber. The front end face of the swirl chamber may be defined by a wall having a frusto-conical portion in the central region which projects inwardly towards the rear end face.

The at least one swirl chamber inlet orifice may be configured to direct fluid into the swirl chamber through the rear end face of the swirl chamber.

The least one swirl chamber inlet orifice may be configured to direct fluid into the swirl chamber through the rear end face non-tangentially, along a path that extends from the inlet across at least part of the chamber before contacting a surface region of the of the chamber.

There may be two or more swirl chamber inlet orifices, each being configured to direct fluid into the chamber through the rear end face of the chamber. The two or more swirl chamber inlet orifices may be configured to direct the fluid into the swirl chamber along paths that are non-tangential to the rear end face of the chamber. The two or more swirl chamber inlet orifices may be configured to direct fluid into the chamber along paths that do not cross within the chamber. The two or more swirl chamber inlet orifices may be configured to direct fluid into the chamber along substantially parallel paths. At least one of said two or more swirl chamber inlet orifices may have a larger minimum cross-sectional area than at least one other of said two or more inlet orifices.

The or each swirl chamber inlet orifice may be arranged to direct fluid into the chamber at an angle to the longitudinal axis of the chamber so as to cause the fluid to rotate about the axis in the chamber.

There may be four or more inlet orifices for directing fluid into the swirl chamber.

Where there is more than one swirl chamber inlet orifice, the nozzle may be configured so that the same fluid is fed into the chamber through all of the inlet orifices. The fluid may be a liquid or a liquid/gas mixture. Alternatively, the nozzle may be configured so that a first fluid from a first fluid source can be fed into the chamber through at least one of the inlet orifices and a second fluid from a second fluid source can be fed into the chamber through at least one other of the inlet orifices. The first fluid may be a liquid or a mixture of a liquid and a gas. The second fluid may be a liquid or a mixture of a liquid and a gas or a gas. The inlet orifices may be configured to cause the first and second fluids rotate about the chamber in the same general direction or they may be configured to cause the fluids to rotate in generally opposite directions.

The fluid flow passage means may comprise two or more of said swirl chambers arranged in series. In which case, the outlet orifice of the final chamber in the series will comprise the final outlet orifice of the nozzle.

The fluid flow passage means may comprise two or more of said swirl chambers arranged in parallel, the outlet orifice of each said swirl chamber being a final outlet orifice of the nozzle.

The nozzle may have more than one outlet orifice, in which case two or more outlet orifices may extend through the front face the, or one of the, swirl chambers.

The nozzle may include a frusto-conical recess in an outer front face of the nozzle around the, or each outlet orifice. The recess may be configured so that the length of the outlet orifice is reduced to a minimum. Preferably, the length of the outlet orifice is no more than 0.6 mm.

In accordance with a second aspect of the invention, there is provided a fluid dispenser comprising a nozzle arrangement according to the first aspect of the invention.

The dispenser may comprise an aerosol canister. The aerosol canister may contain a liquid product with a propellant which is at least partly present in solution in the liquid product. Alternatively, the dispenser may comprise a manually actuated pump dispenser. In which case, the dispenser may be configured to dispense a mixture of liquid and gas. The dispenser may be configured to mixture of liquid and air.

Several embodiments of the invention will now be described, by of example only, with reference to the accompanying drawings, in which:

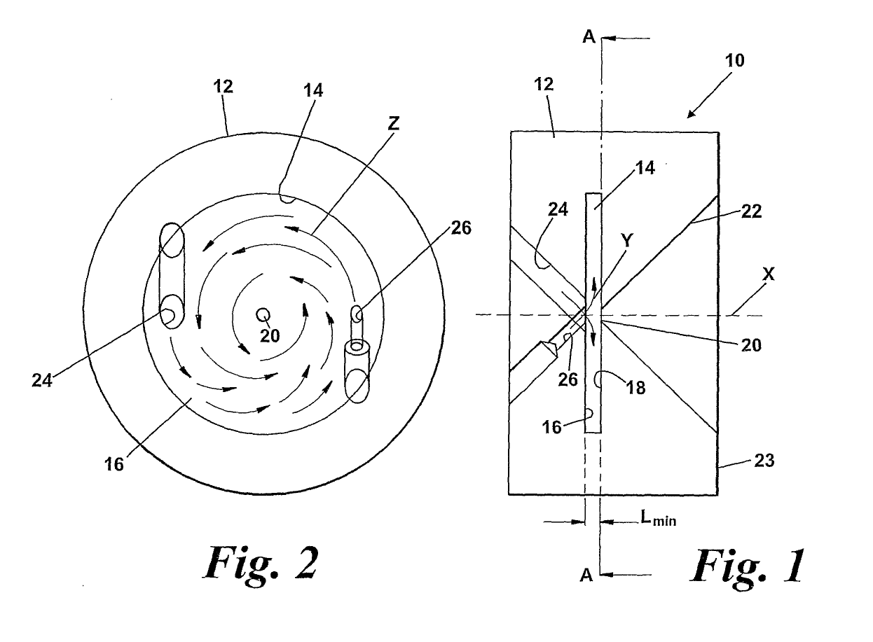

FIG. 1 is a schematic, composite longitudinal cross-sectional view through an outlet end portion of a nozzle in accordance with the invention on an enlarged scale,

FIG. 2 is a schematic lateral cross-sectional view of the nozzle of FIG. 1 taken on line A-A;

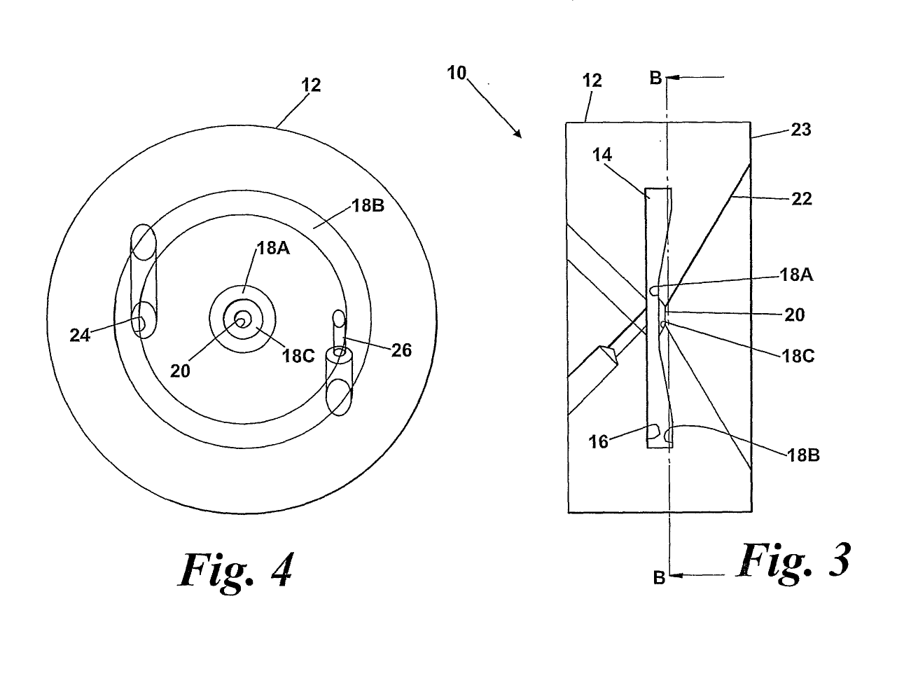

FIG. 3 is a view similar to that of FIG. 1 of an outlet end portion of a second embodiment of a nozzle in accordance with the invention;

FIG. 4 is a schematic lateral cross-sectional view of the nozzle of FIG. 3 taken on line B-B;

FIG. 5 is a view similar to that of FIG. 1 of an outlet end portion of a third embodiment of a nozzle in accordance with the invention;

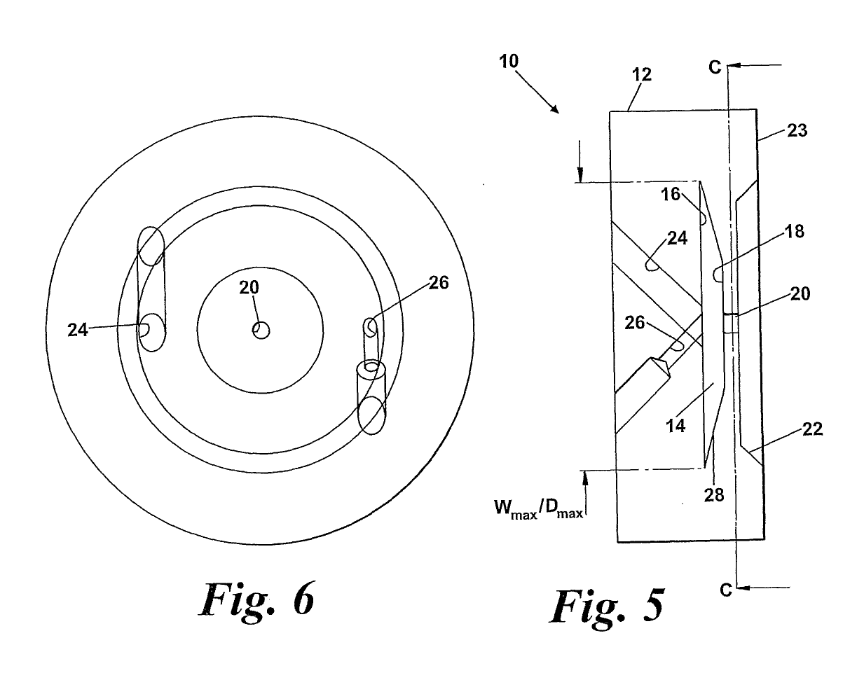

FIG. 6 is a schematic lateral cross-sectional view of the nozzle of FIG. 5 taken on line C-C;

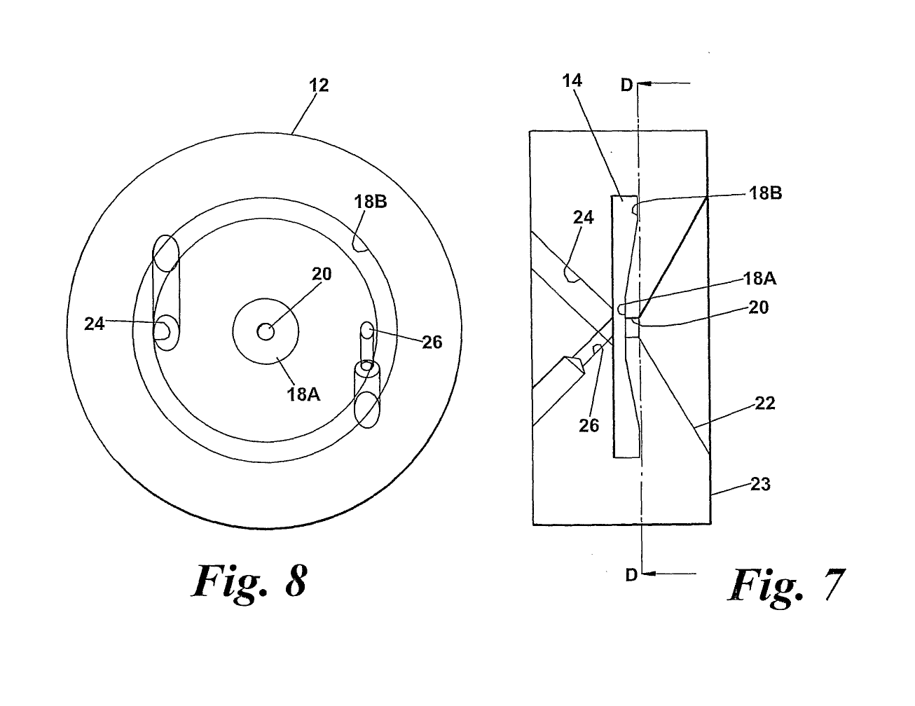

FIG. 7 is a view similar to that of FIG. 1 of an outlet end portion of a fourth embodiment of a nozzle in accordance with the invention;

FIG. 8 is a schematic lateral cross-sectional view of the nozzle of FIG. 7 taken on line D-D;

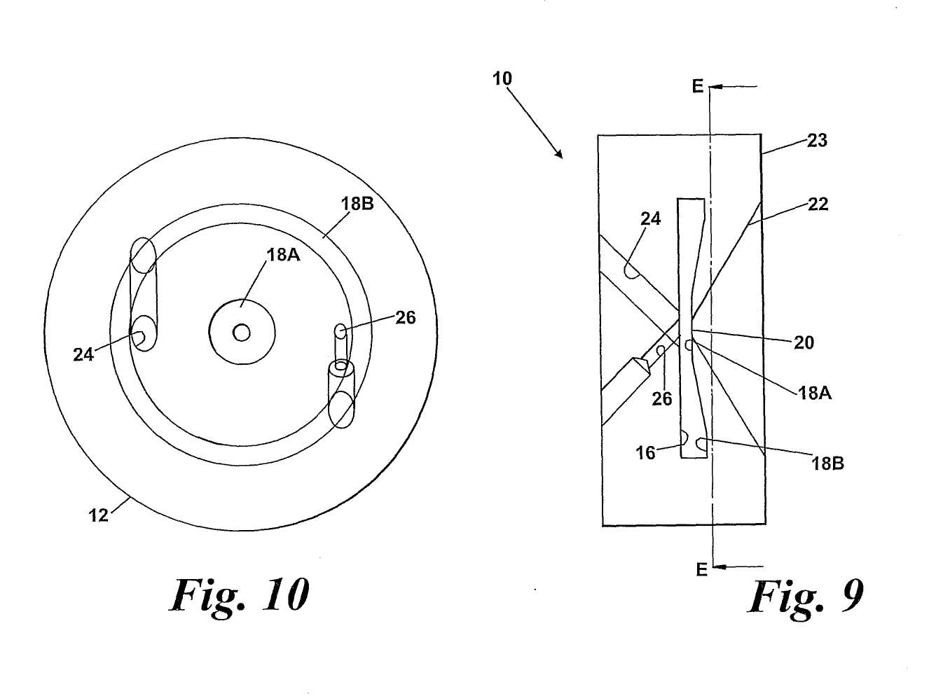

FIG. 9 is a view similar to that of FIG. 1 of an outlet end portion of a fifth embodiment of a nozzle in accordance with the invention;

FIG. 10 is a schematic lateral cross-sectional view of the nozzle of FIG. 9 taken on line E-E;

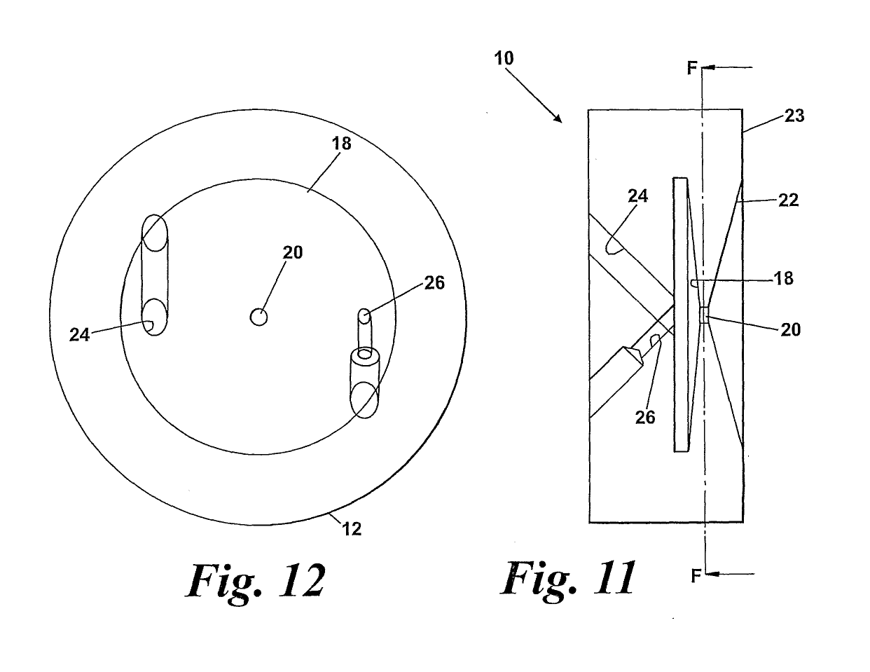

FIG. 11 is a view similar to that of FIG. 1 of an outlet end portion of a sixth embodiment of a nozzle in accordance with the invention;

FIG. 12 is a schematic lateral cross-sectional view of the nozzle of FIG. 11 taken on line F-F;

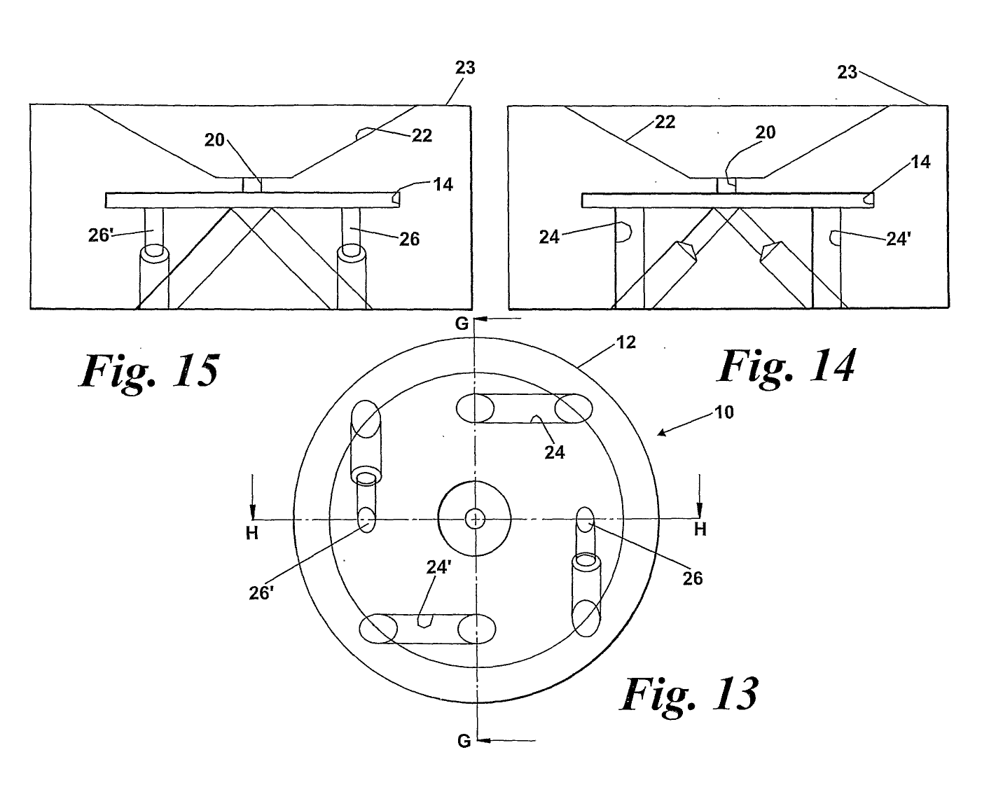

FIG. 13 is a view similar to that of FIG. 2 of an outlet end portion of a seventh embodiment of a nozzle in accordance with the invention;

FIG. 14 is a schematic, composite longitudinal cross-sectional view of the nozzle of FIG. 13 taken on line G-G;

FIG. 15 is a schematic longitudinal cross-sectional view of the nozzle of FIG. 13 taken on line H-H;

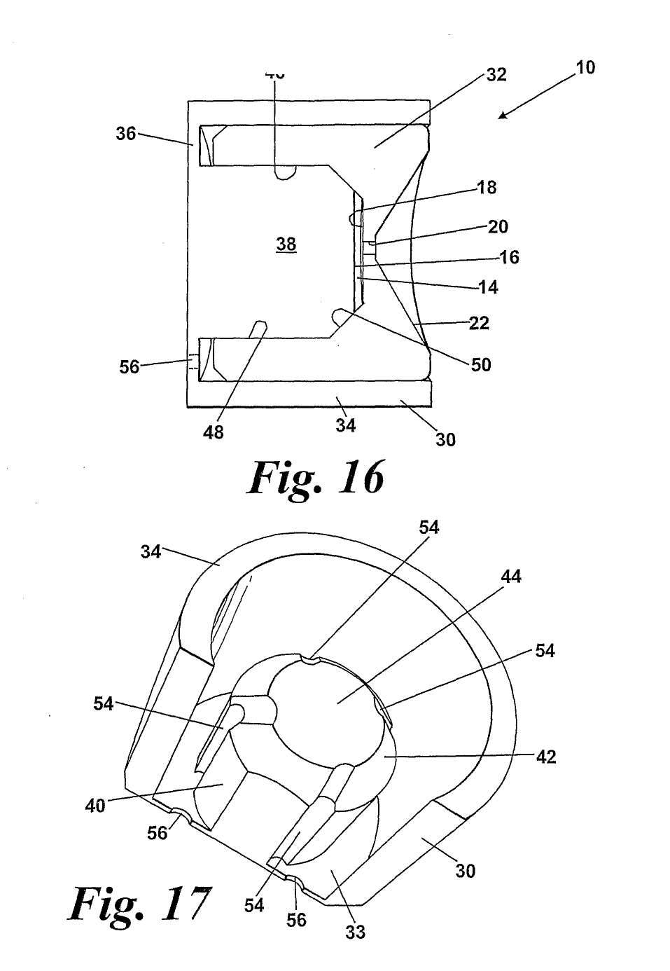

FIG. 16 is a longitudinal cross-sectional view though an eighth embodiment of a nozzle in accordance with the invention; and,

FIG. 17 is a partially sectioned perspective view of a main body forming part of the nozzle of FIG. 16.

With reference initially to FIGS. 1 and 2, there is shown schematically an outlet end portion of a nozzle, indicated generally at 10.

The end portion of the nozzle 10 comprises a body 12 in which is formed a swirl chamber 14 having a rear or downstream end face defined by wall 16 and a front or upstream end face defined by wall 18. The chamber 14 is generally circular in lateral cross section (as shown in FIG. 2) and has an outlet orifice 20 in the centre of the front end face 18 of the chamber. The outlet orifice 20 is a final outlet orifice of the nozzle 10 and opens into a conical recess 22 in an outer front face 23 of the nozzle. The conical recess 22 diverges outwardly towards the front face 23.

Two inlet orifices defined by channels 24, 26 direct a fluid or fluids into the chamber 14 through the rear end wall 16. The inlet orifices 24, 26 are arranged non-tangentially to the surface of the rear end wall 16. By “non-tangentially”, it is meant that the fluid entering the swirl chamber 14 through each orifice 24, 26 is directed into the chamber away from the surface of the wall 16 immediately surrounding the orifice. This should be contrasted with a conventional swirl chamber arrangement in which the inlet orifices typically direct the fluid into the chamber tangentially onto a curved side wall region of the chamber. In the present embodiment, the inlet orifices 24, 26 direct the fluid across the chamber onto the front end wall 18.

The use of non-tangential inlets 24, 26 through the rear end wall 16 in the present embodiment is thought to be advantageous because the fluid entering the chamber 14 is not subjected the same level of friction as the fluid in a conventional swirl. Thus, using non-tangential inlets reduces energy losses in the fluid which enables the swirl to produce a good spray pattern even at low operating pressures as there is more energy in the fluid to assist in the break-up or atomization of the fluid. This also enables the nozzle to be used effectively with solutions that are otherwise difficult to atomize.

The inlet channels 24, 26 are arranged in different planes, one on either side of the chamber and are angled at approximately 30 degrees to the longitudinal axis X of the chamber 14 to direct fluid along paths (indicated by the arrows Y in FIG. 1) that are mutually divergent towards the flat front end wall 18.

It will be noted that FIG. 1 is a composite longitudinal cross sectional view which shows the positions of both inlet orifices 24, 26 and the outlet orifice 20 even though they are in different longitudinal planes. FIGS. 3, 5, 7, 9, 11, 14, 15 and 17 are similar views.

In use, the fluid streams entering the chamber 14 through the inlet orifices 24, 26 strike the front end wall 18 at an angle and the fluid is deflected so as to rotate or spin about the longitudinal axis X of the chamber 14 as indicated by the arrows Z in FIG. 2. Because the inlet orifices 24, 26 are angled in opposite directions on either side of the chamber, fluid streams from both inlet orifices 24, 26 are caused to rotate about the chamber 14 in the same circumferential direction. However, in alternative embodiments, the inlet orifices can be arranged to cause the fluid streams to rotate about the chamber in opposite directions.

As shown in FIGS. 1 and 2, one of the inlet orifices 26 has a smaller minimum cross sectional area than the other inlet channel 24. This arrangement is preferred as it helps to promote mixing of the fluid in the chamber 14. However, the inlet channels 24, 26 could be the same size.

Whilst it is preferred that the nozzle 10 has two or more inlet orifices which direct fluid into the swirl chamber non-tangentially through the rear end face 16, other inlet arrangements can be used. For example, the nozzle may have only a single inlet orifice into the swirl chamber and any or all of the inlet orifices may be arranged tangentially or non-tangentially. Furthermore, one or more inlet orifices may direct fluid into the swirl chamber through a side wall of the chamber and these can also be tangential or non-tangential.

Although not shown in the FIGS. 1 and 2, the inlet orifices 24, 26 form part of a fluid passage of the nozzle 10 which connect one or more fluid inlets of the nozzle to the final outlet orifice 20.

The nozzle 10 may be arranged so that the same fluid is directed into the chamber 14 through both the inlet orifices 24, 26. The fluid will typically be a liquid, such as a liquor, but may be a mixture of liquid and gas. For example, where the nozzle is used with an aerosol canister, the fluid may be a liquid containing a gas such as butane or carbon dioxide in suspension. Alternatively, the liquid may contain a gas, such as air or nitrogen, which has been mixed with the liquid upstream of the inlet orifices 24, 26. In this case, the liquid and gas may be mixed in the nozzle upstream of the inlet orifices 24, 26 or they may be mixed prior to entering the nozzle 10. Where the same fluid is fed into the swirl chamber 14 through the inlet orifices 24, 26, the inlet orifices may connect the swirl chamber 14 with an expansion chamber (not shown) formed in the fluid passageway upstream of the swirl chamber.

In a further alternative arrangement, the nozzle 10 may be configured so that each inlet orifice 24, 26 feeds a different fluid into the swirl chamber 14 so that the two fluids are mixed in the swirl chamber. Thus one of the inlet orifices 24, 26 will feed a first fluid into the swirl chamber 14 whilst the other of the inlet orifices 24, 26 feeds a second fluid into the swirl chamber. The first and second fluids may both be liquids or one or both may be a liquid/gas mixture. Alternatively, one of the fluids may be a liquid and the other a gas. Where the inlet orifices 24, 26 are arranged to feed different fluids into the swirl chamber, the fluid flow passageway means includes separate fluid flow passageway portions for connecting different fluid sources to the inlet orifices 24, 26. Thus, in this arrangement, the nozzle will have two fluid inlets, one for each fluid, and a separate fluid flow passageway portion which connects each inlet with a respective one of the swirl chamber inlet orifices 24, 26. In alternative embodiments, there may be more than two inlet orifices to the swirl chamber, in which case the orifices may be connected with two or more fluid sources in any convenient manner.

In accordance with the invention, the swirl chamber 14 has a minimum length (Lₘᵢₙ) between the rear end face 16 and the front end face 18 in the range of 0.03 mm to 0.6 mm and the ratio of the maximum width (Wₘₐₓ) of the chamber to its minimum length (Wₘₐₓ/Lₘᵢₙ) is in the range 10:1 to 40:1. More preferably, the chamber 14 has a minimum length in the range 0.1 to 0.3 mm.

The term maximum width (Wₘₐₓ) refers to the maximum lateral dimension of the chamber measured in any direction at right angles to the longitudinal axis of the chamber. In the present embodiment, the chamber 14 is cylindrical and its maximum width is its diameter D, which in this case is 4 mm. It is expected that in most embodiments the chamber will be generally circular in lateral cross section to promote spinning of the liquid about the longitudinal axis of the chamber. However, as previously noted in some cases the chamber will not be perfectly circular. For chambers whose lateral cross-sectional profile is not perfectly circular, the diameter D of the chamber can be taken from an imaginary circle which contacts the inner surface of the chamber. In some embodiments, the chamber may have side wall that tapers inwardly towards one end or the other. For example, the chamber may be generally frusto-conical in shape. In these cases, the maximum width of the chamber will be its largest diameter (Dₘₐₓ) and the ratio of maximum width to minimum length Wₘₐₓ/Lₘᵢₙ can be rewritten as Dₘₐₓ/Lₘᵢₙ.

It has been found that a swirl chamber 14 which is shorter in length and which has a larger Wₘₐₓ/Lₘᵢₙ (Dₘₐₓ/Lₘᵢₙ) ratio than conventional swirl chambers results in improved atomisation of the fluid, producing smaller droplet sizes and narrower droplet size distributions. This is particularly so where the fluid is a mixture of liquid and gas but has also been found to be true where the fluid contains no or only minimal amounts of gas. Furthermore, it has been found that in nozzles 10 in accordance of the invention, the finer droplets produced in the spray are carried further before falling towards the ground than with a conventional nozzle. Where the fluid comprises a mixture of liquid and gas, it is believed that a short but wide swirl chamber 14 in accordance with the invention forces the gas into smaller bubbles which are entrained in the liquid droplets and which expand as they exit the outlet orifice 20 to break up the droplets into even smaller droplets. Nozzles in accordance with the invention have also been found to have an increased flow rate. In tests, an increase in flow rate of 15% or more has been recorded through the shorter, wider chamber used in the inventive nozzle when compared with a conventional swirl camber having the same inlet and outlet orifice sizes.

Whilst the scope of the invention covers nozzle arrangements in which fluid inlets introduce fluid into the swirl chamber from the side, it is expected that in most applications the inlet or inlets will enter through the rear end face. With such short chambers, the size of the inlets that can be formed in the side walls is limited which may make it difficult to achieve the required flow rates.

The conical recess 22 into which the outlet orifice 20 opens provides a sharp edge at the exit of the outlet orifice 20 and reduces the length of the outlet orifice 20. This arrangement has been found to be particularly beneficial in helping to prevent any gas bubbles in the fluid from expanding as there is little room for them to expand in and because there is only a minimal pressure drop across the outlet orifice 20 before the spray enters the cone. Preferably, the outlet orifice has a length of 0.6 mm or less.

FIGS. 3 to 15 illustrate a number of alternative embodiments of the invention. It should be appreciated that the most of the comments made above in respect of the first embodiment will apply equally to the following embodiments. It should also be noted that any individual feature described in relation to any one of the various embodiments may be combined with any of the features described in relation to any other of the various embodiments.

The same reference numerals are used throughout to designate corresponding features in each of the embodiments.

FIGS. 2 and 3 illustrate a nozzle 10 having a swirl chamber 14 similar to that of the first embodiment; the only differences being in the shape of the front end face 18. In this embodiment, the wall 18 defining the front end face of the chamber 14 has a frusto-conical central region 18A which projects into the chamber towards the rear end face 16. This serves to reduce the length of the chamber 14 in the central region 18A compared to a radially outer region 18B surrounding the central region 18A. The front end wall 18 also has an inner frusto-conical recess 18C surrounding the outlet orifice 20. This inner recess tapers inwardly towards the outlet orifice where it meets with the conical recess 22 in the outer front wall 23 of the nozzle to form a double frusto-conical arrangement. This use of an inner conical recess 18C surrounding the outlet orifice 20 helps to guide the fluid into and through the outlet orifice and, in combination with the outer recess 22, reduces the length of the narrowest portion of the outlet orifice 20 to a minimum.

In the embodiment shown in FIGS. 5 and 6, the side wall 28 of the swirl chamber 14 tapers inwardly from the rear end 16 to the front end 18 so that the chamber 14 is frusto-conical in shape. The outlet orifice 20 in this embodiment is longer than in the previous embodiments and opens into a flat bottomed, frusto-conical recess 22 in the outer surface of the front end wall 23 of the nozzle. In this embodiment, the maximum with (Wₘₐₓ) of the chamber is its largest diameter (Dₘₐₓ) which is measured at the rear end wall

FIGS. 7 and 8, illustrate an embodiment of a nozzle 10 which is similar to that described above in relation to FIGS. 3 and 4, except that there is no inner conical recess surrounding the outlet orifice 20 of the swirl chamber 14. Rather, in this embodiment, the outlet orifice 20 has an increased length over which the side walls of the outlet orifice are parallel before it opens into the conical recess 22 in the outer face of the front wall 23 of the nozzle.

The embodiment in FIGS. 9 and 10 is very similar to the previous embodiment except that the length of the outlet orifice has been reduced to a minimum by extending the conical recess 22 in the front end wall 23 of the nozzle in towards the outlet orifice as far as possible. This produces a sharp edge at the outlet orifice 20.

The next embodiment, illustrated in FIGS. 11 and 12 has a conical front end wall 18 which tapers inwardly toward the outlet orifice 20. This arrangement helps to guide the fluid into and through the outlet orifice which has an increased length over which the side walls of the outlet orifice are parallel before it opens into the conical recess 22 in the outer face of the front wall 23 of the nozzle.

In all the embodiments described so far, there have been two inlet orifices 24, 26 into the swirl chamber 14. FIGS. 13 to 15 illustrate an embodiment having four inlet orifices 24, 24′ and 26, 26′ all of which direct fluid into the chamber non-tangentially through the rear end face 16. Two of the inlet orifices 26, 26′ have a smaller minimum cross section than the other two inlet orifices 24, 24′. The inlet orifices are arranged in pairs on opposite sides of the chamber and are angled so that they direct fluid into the chamber so that the fluid spins in same circumferential direction. However, it will be appreciated that the inlet orifices could be arranged to direct fluid into the chamber in many different ways. For example, the inlet orifices may be arranged to direct fluid into the chamber along paths that cross or so that the fluid entering through one or more inlet orifices is caused to spin in one direction and the fluid entering through one or more other orifices is caused to spin in the opposite direction. The front end face 18 of the swirl chamber 14 in this embodiment is flat and the outlet orifice 20 opens in to a flat bottom portion 22A of a frusto-conical recess 22 in the outer front face 23 of the nozzle.

As noted above, the features of any of the embodiments described can be combined in various ways. For example, any of the embodiments illustrated in FIGS. 1 to 12 could be modified to have four inlet orifices as illustrated in FIGS. 13 to 15.

The conical recesses 22 in the outer front surfaces of the front walls 23 of the nozzles are provided to reduce the length of the outlet orifice 20 and to create a sharp edge at the exit from the outlet orifice. Typically, the spray formed at the outlet orifice will not fill the conical recesses 22.

Whilst it has been found to be advantageous to have the outlet orifice open into a conical recess 22, in certain applications it has also been found to be advantageous for the outlet orifice 20 to open into a cylindrical chamber or tube (not shown) in the outer front surface of the front wall 23 of the nozzle, which chamber has a slightly larger diameter than that of the outlet orifice 20. In tests, a cylindrical chamber having a diameter in the region of 0.1 mm and a length of 1 mm was found to produce a narrower spray cone than a nozzle with a conical outer recess but sent the spray further. This arrangement may be desirable where the reach of the spray is of particular importance.

In the embodiments described above, the nozzle has only a single swirl chamber in the fluid passage adjacent the final outlet orifice of nozzle. However, it has been found to be advantageous to provide two or more swirl chambers of the type described herein arranged in parallel and/or series in a nozzle. For example, two or more swirl chambers could be arranged in parallel at the outlet end of the nozzle so that the fluid exiting the outlet orifices of the chambers combines to form a single spray. Alternatively, two or more swirl chambers of the type described herein can be arranged in series along the fluid passage of the nozzle. It will be appreciated that swirl chambers of the type described herein can arranged in parallel and/or series in any desired combination in a single nozzle. Thus in one example, two or more chambers can be arranged in parallel in the fluid passage so that the fluid exiting the chambers is directed into one or more chambers further downstream in the passage. Where there is more than one downstream chamber, these may be arranged in parallel or series.

Nozzle arrangements in accordance with the invention can be adapted for use with liquids of any viscosity and for use in a wide range of applications including dispensers such aerosol canisters or manual pumps Accordingly, nozzle arrangements in accordance with the invention can be adapted for use in delivering a wide range of products in spray form including, but not limited to, antiperspirant sprays, de-odorant sprays, perfumes, air fresheners, antiseptics, paints, insecticides, polish, hair care products, pharmaceuticals, water and lubricants, lotions, insecticides, as well as various garden and household sprays and industrial fluids. However, nozzle arrangements in accordance with the invention are particularly suitable for use with reduced VOC aerosol canisters. Nozzles in accordance with the invention are also particular suitable for use with manual pump dispensers which are configured to dispense a mixture of liquid and air.

Whilst nozzle arrangements in accordance with the invention have particular application in dispensing a liquid mixed with a gas, which may be in solution, they are also beneficial for dispensing a fluid comprising a liquid with little or no gas. In these circumstances, nozzles in accordance with the invention have been found to provide a wide range of spray angles and are capable of producing a full cone spray with wide angle and narrow droplet size distribution.

Nozzle arrangements on accordance with the invention may also be advantageously used in many industrial, agricultural, horticultural, and pharmaceutical applications.

Nozzle arrangements in accordance with the invention can be manufactured form any suitable materials included metal and many plastics such as polypropylene, nylon, acetyl or PVC, for example.

Nozzles in accordance with the invention may be split nozzles that are divided longitudinally into two parts. In this arrangement, the two parts have abutment surfaces that are brought into contact with one another when the parts are assembled. Various groves and or recesses are provided in the abutment surfaces of one or both of the parts which form at least part of the fluid passage, including the swirl chamber.

Alternatively, the swirl chamber may be produced by means of a post and an insert which fits over the post. In this arrangement, the swirl chamber is formed by means of a gap between the free end of the post and an end wall of the insert which defines the front end face of the chamber. Grooves are formed in the side wall of the post and/or the insert to form inlet channels which direct fluid into the chamber and the outlet orifice is formed through the end wall of the insert. An example of a nozzle 10 incorporating this arrangement is shown in FIGS. 16 and 17.

The nozzle 10 includes a main body 30 and an insert 32. In a preferred embodiment, both the main body 30 and the insert 32 are injection moulded from polymeric materials, though they could be made from any suitable materials using any suitable manufacturing methods. The main body has an outer tubular wall 34 which is closed off at the rear or input end by a wall 36 and a post 38 projects from an inner side of the end wall 36 within the tubular outer wall 34. The post has a cylindrical portion 40 with a taper 42 leading to its free end 44. The outer diameter of the cylindrical portion 40 of the post 38 is smaller than the inner diameter of the tubular wall 34 so as to define an annular gap between the post 38 and the outer tubular wall 34.

The insert 32 is circular having an outer diameter which is a close fit within the outer tubular wall 34 of the main body. A bore 46 extends into the insert from an inner end and has a cylindrical portion 48 that fits closely over the cylindrical portion 40 of the post and a tapered portion 50 that matches and fits closely to the tapered portion 42 of the post 38. A swirl chamber 14 is formed by a gap between the free end 44 of the post, which forms the rear end face 16 of the chamber, and an end wall 52 of the insert, which defines the front end wall 18 of the chamber. A frusto-conical recess 22 is provided in the outer surface of the end wall 52 of the insert and an outlet orifice 20 extends through the end wall 52 centrally of the chamber 14 to fluidly connect the chamber to the recess 22.

Four inlet channels for the swirl chamber 14 are formed by means of hemispherical grooves 54 in the outer surface of the post. The grooves 54 extend along the cylindrical portion 40 of the post and the taper 42 where they break though the free end face 44 of the post. One or more openings 56 are formed though the end wall 36 of the main body to provide a fluid inlet to the nozzle 10. The inner end of the insert 32 is spaced from the end wall 36 of the main body so that fluid entering nozzle through the openings 56 is able to enter the grooves 54 on the post and so flow into the swirl chamber 14 where it is caused to spin before exiting the nozzle through the outlet orifice 20.

The grooves 54 are angled across the tapered portion 42 of the post so as to encourage the fluid to spin as it enters the chamber. The taper 42 on the post itself also encourages the fluid to spin. It is advantageous that the channels are hemispherical and abut the flat inner surface of the insert as this also encourages the fluid to curve into the chamber to aid in generating the necessary spinning motion. As shown in FIG. 16, the tapered portion 50 of the insert bore extends beyond the free end 44 of the post to guide the fluid into the chamber at an angle. Formations could be formed on the inner surface of the insert or on the post to aid in guiding the fluid to cause the fluid to spin if required.

In the present embodiment, the grooves are all angled in the same direction so that the fluid entering the chamber through each of the grooves circulates about the chamber is the same rotational direction. However, some of the grooves could be angled in the opposite direction so that the fluid streams from the grooves rotate in different directions. The main body 30 and insert 32 could also be adapted so that two fluids enter through separate inlet openings 56 in the end wall of the main body and are directed into separate grooves 54 on the post so that the fluids are mixed in the chamber 14.

The nozzle 10 as shown in FIGS. 16 and 17 could form part of a manually actuated dispenser or it may be incorporated into an actuator/nozzle for an aerosol can or the like.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention.

Where the terms “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

1-34. (canceled)

35. A nozzle having a fluid inlet, an outlet orifice through which fluid can be expelled from the nozzle in the form of a spray, and fluid flow passage for fluidly connecting the fluid inlet with the outlet orifice, the passage including a swirl chamber immediately upstream of the outlet orifice, the swirl chamber having opposing front and rear end faces, the passage also including at least one inlet orifice through which fluid can be introduced into the swirl chamber with the outlet orifice of the nozzle being provide in the front end face of the swirl chamber, the swirl chamber having a minimum length measured from the front end face to the rear end face in the range of 0.03 mm to 0.6 mm and a ratio of maximum width Wₘₐₓ to minimum length Lₘᵢₙ (Wₘₐₓ/Lₘᵢₙ) in the range of 10:1 to 40:1; characterised in that the least one swirl chamber inlet orifice is configured to direct fluid into the swirl chamber through the rear end face non-tangentially, along a path that extends from the inlet across at least part of the chamber before contacting a surface region of the of the chamber.

36. A nozzle as claimed in claim 35 in which the chamber is generally circular in lateral cross section, the maximum width Wₘₐₓ being its largest diameter Dₘₐₓ.

37. A nozzle as claimed in claim 35, in which the swirl chamber has a minimum length in the range 0.1 mm to 0.3 mm.

38. A nozzle chamber as claimed in claim 35, in which the length of the swirl chamber varies vary across its diameter so that its length is less in a central region surrounding the outlet orifice than in a radially outer region surrounding the central region.

39. A nozzle as claimed in claim 38, in which the front end face of the swirl chamber is shaped to vary the length of the swirl chamber.

40. A nozzle as claimed in claim 39, in which the front end face of the swirl chamber is defined by a wall having a frusto-conical portion in the central region which projects inwardly towards the rear end face.

41. A nozzle as claimed in claim 35, in which the or each swirl chamber inlet orifice is arranged to direct fluid into the chamber at an angle to the longitudinal axis of the chamber so as to cause the fluid to rotate about the axis in the chamber.

42. A nozzle as claimed in claim 35, in which there are two or more swirl chamber inlet orifices, each being configured to direct fluid into the chamber through the rear end face of the chamber.

43. A nozzle as claimed in claim 42, in which the two or more swirl chamber inlet orifices are each configured to direct the fluid into the swirl chamber along paths that are non-tangential to the rear end face of the chamber.

44. A nozzle as claimed in claim 42, in which at least one of said two or more swirl chamber inlet orifices has a larger minimum cross-sectional area than at least one other of said two or more inlet orifices.

45. A nozzle as claimed in claim 42, in which the nozzle is configured so that the same fluid is fed into the chamber through all of the inlet orifices.

46. A nozzle as claimed in claim 45, in which the fluid is a liquid or a liquid/gas mixture.

47. A nozzle as claimed in claim 42, in which the nozzle is configured so that a first fluid from a first fluid source can be fed into the chamber through at least one of the inlet orifices and a second fluid from a second fluid source can be fed into the chamber through at least one other of the inlet orifices.

48. A nozzle as claimed in claim 35, in which the nozzle has more than one outlet orifice.

49. A nozzle as claimed in claim 35, in which a frusto-conical recess is provided in an outer front face of the nozzle around the, or each, outlet orifice.
